(19) United States
(12) Patent Application Publication
(10) Pub. No.: US 2022/0361300 A1
(43) Pub. Date: Nov. 10, 2022

(54) INDUCTION-HEATING SYSTEM INCLUDING A SUSCEPTOR FOR GENERATING INDUCTION HEATING BELOW A SELECTED CURIE TEMPERATURE

(71) Applicant: The Boeing Company, Chicago, IL (US)

(72) Inventors: John R. Hull, Sammamish, WA (US); Jeffrey Peter Baucum, Sammamish, WA (US); Landon Henson, Snoqualmie, WA (US); Marc R. Matsen, Seattle, WA (US)

(21) Appl. No.: 17/695,246

(22) Filed: Mar. 15, 2022

Related U.S. Application Data
(60) Provisional application No. 63/186,467, filed on May 10, 2021.

(51) Int. Cl. H05B 6/36; H05B 6/44; B64D 15/12

(52) U.S. Cl. CPC H05B 6/365; H05B 6/44; B64D 15/12

(57) ABSTRACT

An induction-heating system includes a susceptor located proximate to a flight surface of an aircraft. The susceptor comprises an array of wires arranged along a first axis. The array of wires is constructed of a ferromagnetic material having a selected Curie temperature. The induction-heating system also includes an electrically conductive coil including a plurality of coil windings oriented substantially perpendicular with respect to the first axis of the array of wires. The electrically conductive coil is configured to generate a magnetic field oriented substantially parallel with respect to the first axis of the array of wires. The electrically conductive coil is positioned to induce induction heating within the ferromagnetic material of the susceptor when the susceptor is below the selected Curie temperature.

### CROSS-REFERENCE TO RELATED APPLICATION

This application claims priority to U.S. Provisional Application No. 63/186,467, filed May 10, 2021. The contents of the application are incorporated herein by reference in its entirety.

### INTRODUCTION

The present disclosure relates to an induction-heating system. More particularly, the present disclosure is directed towards an induction-heating system including a susceptor that generates induction heating below a selected Curie temperature of a ferromagnetic material.

### BACKGROUND

An induction-heating anti-icing system for an aircraft generally includes a ferromagnetic susceptor, one or more heating coils, and a power supply for providing alternating current (AC) current to the heating coils. In particular, when used for leading-edge heating in an aircraft's wing, the susceptor is either included in the erosion shield of the wing leading edge or, alternatively, the susceptor is placed immediately behind and thermally contacts the erosion shield. The heating coils are placed immediately behind the susceptor, and when AC current flows in the heating coils, a magnetic field produced by the heating coils is coupled inductively to the susceptor. With a changing magnetic flux in the susceptor, electrical currents are induced in the susceptor, and because the susceptor has electrical resistivity, Joule heating results in the susceptor.

The design constraints for induction-heating systems on vehicles promote the use of flat heating coils, such as a spiral pancake. The flat heating coil will typically follow the contour of the susceptor, which in turn is contoured to follow the profile of the surface on which ice protection is required. For example, the flat heating coil may follow the contour of a wing leading edge, or nose cowl of the engine nacelle. The geometry of the spiral pancake will always result in an area in which a tangential component of the magnetic field produced by the flat heating coil is a minimum. This field minimum occurs because the current flow in the filaments on either side of this area is in opposite directions, and the magnetic field produced by these current flows cancels at the center of the heating coil. In a circular spiral pancake, the field minimum is at the inner origin of the spiral. For an elongated ellipsoidal spiral, the field minimum occurs along a line segment in the middle of the heating coil. The area on the susceptor that is adjacent to the field minimum on the heating coil will be heated much less than the rest of the susceptor. The normal component of the incident magnetic field produces minimal heating in the susceptor. Further, the heat transfer on the vehicle is such that it is predominantly transverse to the thickness of the susceptor. In addition, the susceptor thickness is small. Thus, there is negligible heat transfer within the susceptor from parts of the susceptor where the magnetic field is substantial to the part of the susceptor where the magnetic field is at a minimum.

In light of the above, it is to be appreciated that a relative cold spot is always present on the susceptor. The current flowing through the entire heating coil should be sufficient to heat the cold spot above a temperature at which ice will form. Thus, the current at the cold spot on the susceptor is significantly more than the current required to keep the remaining portion of the susceptor above the ice-forming temperature. As a result, the induction heating is less efficient than it would be if all parts of the susceptor were heated just enough to keep the susceptor above the ice-forming temperature.

In one approach, the susceptor is constructed of a smart susceptor material or materials having a Curie temperature that is less than a threshold value. As portions of the smart susceptor reach the Curie temperature, a relative permeability of the susceptor drops precipitously. The drop in relative permeability has two effects. First, the drop in magnetic permeability limits the generation of heat by the portions of the smart susceptor at the Curie temperature. Second, the drop in relative permeability shifts magnetic flux to lower temperature portions of the smart susceptor, thereby causing the lower temperature portions below the Curie temperature to heat up more quickly to the Curie temperature. This solution reduces the power required as the temperature of the smart susceptor rises. However, this solution does not completely alleviate the issue of increased power consumption, since extra power is still required to keep the cold spot on the susceptor above an ice-forming temperature. Furthermore, it is also to be appreciated that there is usually not a significant difference between the smart susceptor's Curie temperature and the temperature at which the smart susceptor may lose its ferromagnetic properties. In another approach, two overlapping heating coils may be employed, where each heating coil provides the heat for the remaining heating coil's cold spot. However, this approach requires separate power supplies for each heating coil.

Thus, while current anti-icing systems achieve their intended purpose, there is a need in the art for an anti-icing system that provides improved efficiency and uniform heating.

### SUMMARY

According to several aspects, an induction-heating system is disclosed, and includes a susceptor located proximate to a flight surface of an aircraft. The susceptor comprises an array of wires arranged along a first axis. The array of wires are constructed of a ferromagnetic material having a selected Curie temperature. The induction heating system also includes an electrically conductive coil including a plurality of coil windings oriented substantially perpendicular with respect to the first axis of the array of wires, where the electrically conductive coil is configured to generate a magnetic field oriented substantially parallel with respect to the first axis of the array of wires, and the electrically conductive coil positioned to induce induction heating within the ferromagnetic material of the susceptor when the susceptor is below the selected Curie temperature.

According to another aspect, an aircraft is disclosed, and includes a susceptor located proximate to a flight surface of an aircraft. The susceptor comprises an array of wires arranged along a first axis, the array of wires constructed of a ferromagnetic material having a selected Curie temperature. The aircraft also includes an electrically conductive coil including a plurality of coil windings that are oriented substantially perpendicular with respect to the first axis of the array of wires, where the electrically conductive coil is configured to generate a magnetic field oriented substantially parallel with respect to the first axis of the array of wires, and the electrically conductive coil is positioned to induce induction heating within the ferromagnetic material of the susceptor when the susceptor is below the selected Curie temperature. The susceptor generates heat at a first level when the susceptor is below the selected Curie temperature and generates heat at a second level when the susceptor is within a predetermined range of the selected Curie temperature.

In yet another aspect, a method for inductively heating deicing and anti-icing flight surfaces of an aircraft is disclosed. The method includes providing alternating current (AC) power to an electrically conductive coil including a plurality of coil windings that are oriented substantially perpendicular with respect to a first axis of an array of wires that are part of a susceptor. The susceptor is located proximate to the deicing and anti-icing flight surfaces and the array of wires constructed of a ferromagnetic material having a selected Curie temperature. In response to receiving the AC power, the method includes generating, by the electrically conductive coil, a magnetic field oriented substantially parallel with respect to the first axis of the array of wires. Finally, the method includes inducing, by the electrically conductive coil, induction heating within the ferromagnetic material of the susceptor when the susceptor is below the selected Curie temperature to heat the deicing and anti-icing flight surfaces.

The features, functions, and advantages that have been discussed may be achieved independently in various embodiments or may be combined in other embodiments further details of which can be seen with reference to the following description and drawings.

### BRIEF DESCRIPTION OF THE DRAWINGS

The drawings described herein are for illustration purposes only and are not intended to limit the scope of the present disclosure in any way.

FIG. 1 is a side section view of the disclosed induction-heating system, according to an exemplary embodiment;

FIG. 2 is an elevated perspective view of a susceptor that is part of the induction-heating system, according to an exemplary embodiment;

FIG. 3A is an enlarged view of a portion of the susceptor shown in FIG. 2

FIG. 3B is a cross-sectioned view of one of the wires shown in FIG. 3A that are part of the susceptor, according to an exemplary embodiment;

FIG. 4 illustrates a relative permeability versus temperature curve for an exemplary ferromagnetic material that the susceptor is constructed of, according to an exemplary embodiment;

FIG. 5 illustrates an electrically conductive coil of the induction-heating system wound around a core, according to an exemplary embodiment;

FIG. 6 is an alternative embodiment of the susceptor, according to an exemplary embodiment;

FIG. 7 is an illustration of an alternative embodiment of the electrically conductive coil wound around the core;

FIG. 8 illustrates yet another embodiment of the electrically conductive coil wound around the core;

FIG. 9 illustrates still another embodiment of the electrically conductive coil wound around the core; and

FIG. 10 illustrates yet another embodiment of the electrically conductive coil wound around the core; and

FIG. 11 is a process flow diagram illustrating a method for inductive heating for deicing and anti-icing the flight surfaces, according to an exemplary embodiment.

### DETAILED DESCRIPTION

The present disclosure relates to an induction-heating system including a susceptor that generates induction heating below a selected Curie temperature of a ferromagnetic material, where the susceptor includes an array of wires constructed of the ferromagnetic material. The induction-heating system also includes an electrically conductive coil having a plurality of coil windings oriented substantially perpendicular with respect to the array of wires of the susceptor. The electrically conductive coil is positioned to induce induction heating within the ferromagnetic material of the susceptor when the susceptor is below the selected Curie temperature. The susceptor material and geometry are selected so that the susceptor generates a first level of heat when the susceptor is at a relatively cold temperature, such as temperatures at or below the freezing point of water. However, once the susceptor is heated to a leveling temperature range of the ferromagnetic material, then the amount of heat generated by the susceptor is substantially reduced to a second level of heat, where a ratio between the first level and the second level of heating is at least 10:1. The level of heating is substantially reduced once the susceptor is at the leveling temperature range because a relative permeability of the ferromagnetic material of the susceptor decreases monotonically at the leveling temperature range.

The following description is merely exemplary in nature and is not intended to limit the present disclosure, application, or uses.

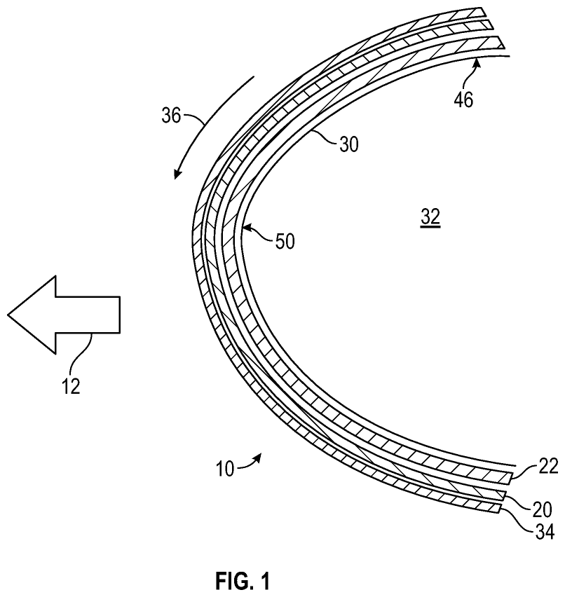

Referring to FIG. 1, an exemplary induction-heating system 10 is illustrated. The induction-heating system 10 includes a susceptor 20 and an electrically conductive coil 22. The susceptor 20 is located proximate to a flight surface 30 of an aircraft 32, where a direction of travel 12 of the aircraft 32 is indicated by an arrow. In one embodiment, the induction-heating system 10 also includes an erosion shield 34 that is located at a forward direction 36 of the aircraft 32 relative to the susceptor 20. The erosion shield 34 surrounds the susceptor 20 and provides protection from wind and rain erosion. However, in some embodiments the susceptor 20 acts as the erosion shield, and therefore a separate component may not be required. The flight surface 30 of the aircraft 32 is any type of flight control surface such as, but not limited to, a leading edge of a wing, the trailing edge of a wing, an engine cowling, and an empennage of the aircraft 32. In an embodiment, the induction-heating system 10 is part of an anti-icing system that provides uniform heating to the flight surface 30 of the aircraft 32. As explained below, the electrically conductive coil 22 induces induction heating within the susceptor 20 when the susceptor 20 is below a selected Curie temperature.

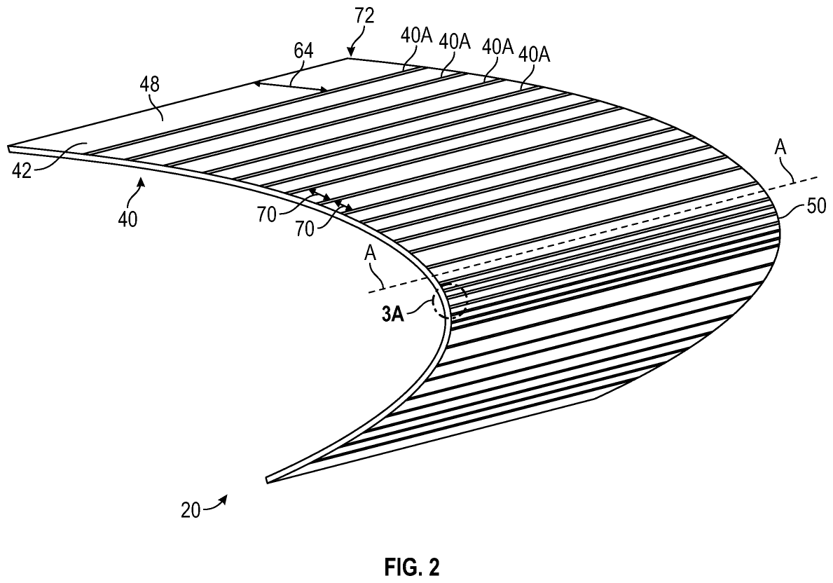

FIG. 2 is an elevated perspective view of one embodiment of the susceptor 20. The susceptor 20 includes an array of wires 40 and a support substrate 42. The support substrate 42 provides mechanical support to the array of wires 40. In one non-limiting embodiment, the array of wires 40 are embedded along an outer surface 48 of the support substrate 42. In another embodiment, the array of wires 40 may be embedded into a thin sheet of flexible material such as rubber, where the thin sheet is placed over the outer surface 48 of the support substrate 42. The support substrate 42 is shaped to correspond with an outer contour 46 of the flight surface 30 (FIG. 1). Accordingly, it follows that the array of wires 40 of the susceptor 20 are also oriented to follow the outer contour 46 of the flight surface 30. In an embodiment, the support substrate 42 is constructed of thermoplastic or thermoset material, which may include reinforcing fibers. In an example, the reinforcing fibers of the support substrate 42 include aluminoborosilicate glass with less than 1% w/w alkali oxides, aluminosilicate glass, or carbon fibers.

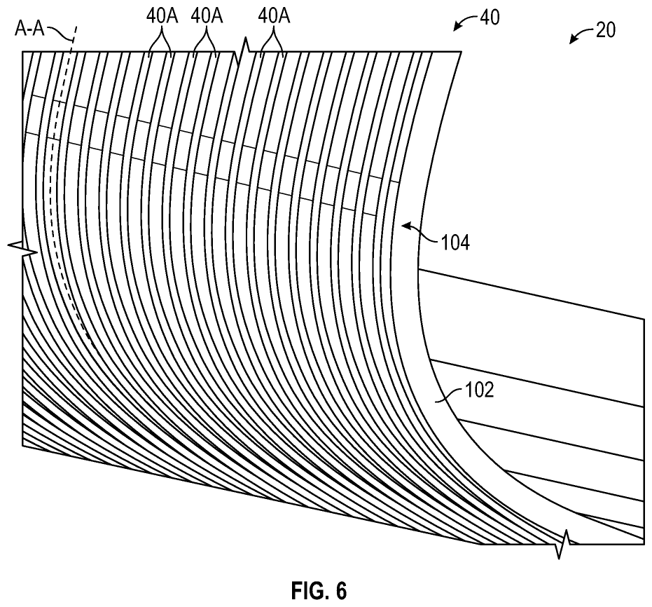

The array of wires 40 extend along a first axis A-A and are positioned substantially parallel with respect to one another. Referring to FIGS. 1 and 2, in one embodiment the first axis A-A extends spanwise and is substantially parallel with respect to a leading edge 50 of the flight surface 30. Accordingly, the array of wires 40 are arranged spanwise and are also oriented parallel with respect to the leading edge 50 of the flight surface 30. In the embodiment as shown in FIG. 2, the wires 40A of the array of wires 40 are spaced at different distances apart from one another based on proximity to the leading edge 50 of the flight surface 30. As explained below, the wires 40A are spaced so that more heat is generated along the leading edge 50 of the flight surface 30. However, it is to be appreciated that the arrangement shown in FIG. 2 is merely exemplary in nature. In another embodiment as seen in FIG. 6, the wires 40A are spaced at equal distances from one another.

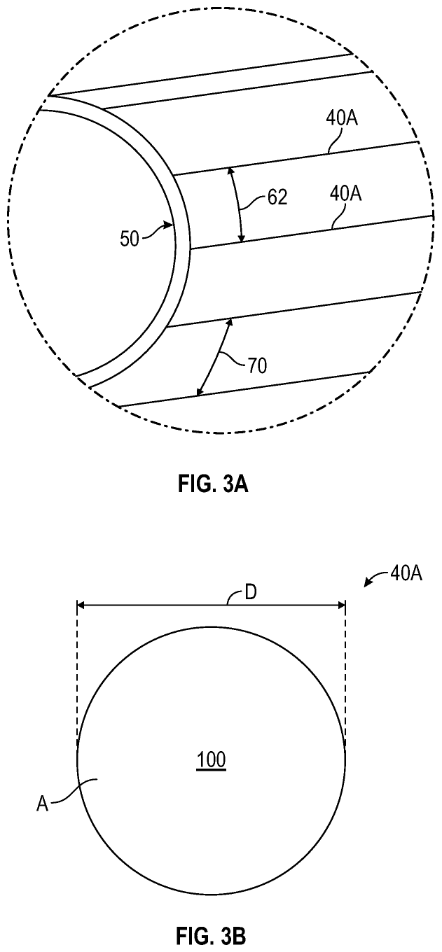

FIG. 3A is an enlarged view of a portion of the susceptor 20 taken along the leading edge 50 of the flight surface 30, and FIG. 3B is an exemplary cross-sectioned view of one of the wires 40A that are part of the array of wires 40. Referring to FIGS. 3A and 3B, in one embodiment each wire 40A of the array of wires 40 are each spaced at least a minimum distance 62 apart from one another. In one embodiment, the minimum distance 62 is equal to at least one-half of a wire diameter D. In another embodiment, the minimum distance 62 is equal to the wire diameter D. The minimum distance 62 is sized so the wires 40A are each electrically isolated from one another. It is to be appreciated that while FIG. 3B illustrates the wire 40A having a circular cross-sectional area, the wire 40A is not limited to a particular geometry. For example, in another embodiment, the wire 40A includes a square or rectangular profile instead.

Referring to FIGS. 2 and 3A, in the embodiment as shown each wire 40A of the array of wires 40 of the susceptor 20 are spaced at the minimum distance 62 at the leading edge 50 of the flight surface 30. However, a wire distance 70 that is measured between each wire 40A is variable. Accordingly, in the embodiment as shown in FIG. 2, the wire distance 70 between the wires 40A increases as a distance between an individual wire 40A and the leading edge 50 of the flight surface 30 increases. Specifically, in the example as shown in FIG. 2, the wires 40A located at a maximum distance 72 from the leading edge 50 of the flight surface 30 are spaced at a maximum distance 64 from one another. It is to be appreciated that spacing the individual wires 40A closer to one another generates more heat when induction heating is induced, which is described in greater detail below. Therefore, more heat is generated along the leading edge 50 of the flight surface 30, which may be advantageous for de-icing purposes.

The array of wires 40 are each constructed of a ferromagnetic material having a selected Curie temperature. It is to be appreciated that the selected Curie temperature is less than a structural temperature of the material of the flight surface 30. In one embodiment, ferromagnetic material of the susceptor 20 is constructed of at least one of a nickel iron alloy, a nickel iron chromium alloy, a nickel iron copper alloy, a nickel iron vanadium alloy, a nickel cobalt copper alloy, a nickel copper alloy, and a nickel aluminum alloy.

The susceptor 20 generates an intense amount of heat when the susceptor 20 is at a relatively cold temperature, such as temperatures at or below the freezing point of water. However, once the susceptor 20 is heated, the amount of heat generated by the susceptor 20 is reduced substantially. Specifically, the ferromagnetic material of the susceptor 20 is selected so the susceptor 20 generates heat at a first level when the susceptor 20 is below the selected Curie temperature and generates heat at a second level when the susceptor 20 is within a predetermined range of the selected Curie temperature, where the first level is greater than the second level of heating. A ratio between the first level and the second level of heating is at least 10:1. In an embodiment, the ratio between the first level and the second level of heating ranges between 50:1 to 100:1.

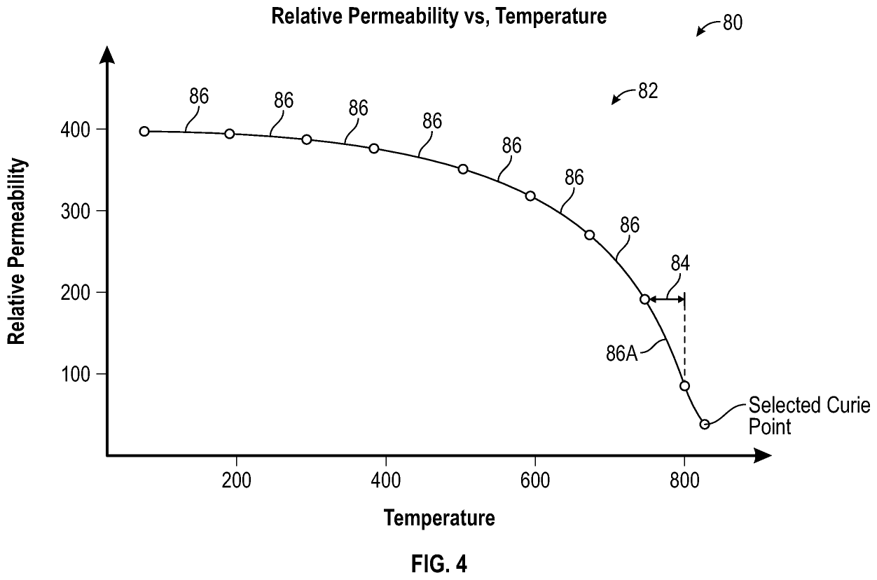

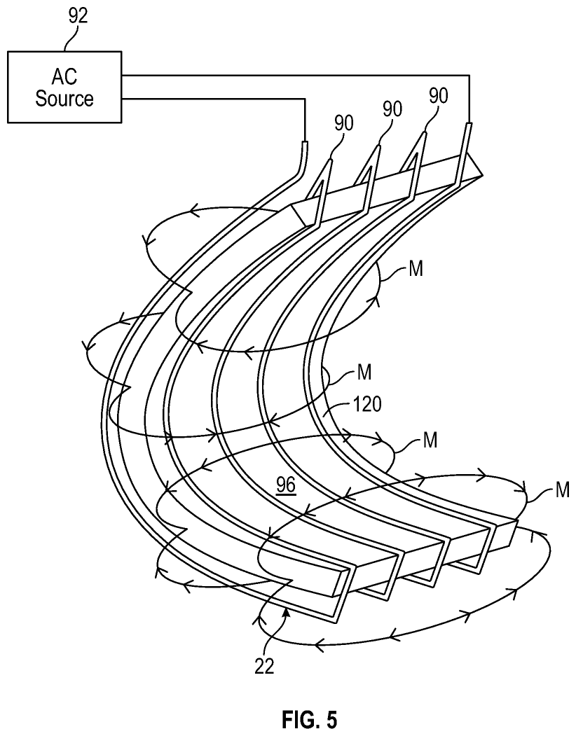

The predetermined range is equal to a leveling temperature range of the susceptor 20. The leveling temperature range of the susceptor 20 is based on a relative permeability versus temperature curve of the ferromagnetic material that the susceptor is constructed of, the diameter D (FIG. 3A) of the individual wires 40A, a number of wires 40A that are part of the array of wires 40, a magnetic field M (FIG. 5), and magnetic hysteresis heating. The magnetic field M is induced by the susceptor 20 when the electrically conductive coil 22 is provided with alternating current (AC) power and is described in detail below. Referring now to FIG. 4, a relative permeability versus temperature curve 80 for an exemplary ferromagnetic material that the susceptor 20 is constructed of is shown. The relative permeability versus temperature curve 80 shown in FIG. 4 includes an x-axis indicating temperature, a y-axis indicating relative permeability, and a thermal profile 82 that is based on a wire having a given diameter that is constructed of the ferromagnetic material.

As seen in FIG. 4, the thermal profile 82 indicates that heating within the ferromagnetic material causes the relative permeability to decrease in value. Specifically, as the temperature of the ferromagnetic material approaches the selected Curie point, the relative permeability decreases monotonically. A leveling temperature range 84 of the ferromagnetic material is located along a portion or segment 86A of the thermal profile 82 where the relative permeability decreases monotonically as the temperature decreases. Specifically, the thermal profile 82 is composed of a plurality of segments 86. The leveling temperature range 84 of the ferromagnetic material is equal to the segment 86A of the thermal profile 82 having the steepest negative slope. It is to be appreciated that as the ferromagnetic material reaches the leveling temperature range 84, the ferromagnetic material reaches thermal equilibrium. That is, there is a uniform temperature distribution throughout the body 100 of the cross-sectional area A (FIG. 3B) of the individual wire 40A of the susceptor 20.

Referring to FIGS. 2 and 4, the leveling temperature range 84 of the ferromagnetic material is affected by the geometry of the susceptor 20. That is, the leveling temperature range 84 of the ferromagnetic material varies based on the diameter D (FIG. 3) of the individual wires 40A and the number of wires 40A that are part of the array of wires 40. Both an amplitude and a frequency of the magnetic field M (shown in FIG. 5) affects the leveling temperature range 84 of the ferromagnetic material. For example, increasing the number of wires or increasing the amplitude or the frequency of the magnetic field M causes the thermal profile 82 of the relative permeability versus temperature curve 80 of the ferromagnetic material to increase, or shift towards the right. Accordingly, the leveling temperature of the actual susceptor 20 itself may vary based on the geometry of the susceptor 20 as well as the magnetic field M.

FIG. 5 is an illustration of the electrically conductive coil 22 wound around a core 120. The core 120 is constructed of ferrite, which is magnetic but does not electrically conduct. The electrically conductive coil 22 is constructed of a conductive material such as, for example, Litz wire. As seen in FIG. 5, an AC source 92 is electrically connected to and provides AC power to the electrically conductive coil 22. In an embodiment, the AC source 92 provides AC power at about 400 kilohertz, however, it is to be appreciated that any frequency between about 10 kilohertz to about 1 megahertz may be used as well. Referring to FIGS. 2 and 5, the electrically conductive coil 22 is positioned relative to the susceptor 20 to induce induction heating within the ferromagnetic material of the susceptor 20 when the susceptor is below the selected Curie temperature.

The electrically conductive coil 22 includes a plurality of coil windings 90, where the coil windings 90 surround an outer surface 96 of the core 120. Referring to both FIGS. 2 and 5, the coil windings 90 are oriented substantially perpendicular with respect to the first axis A-A of the array of wires 40 (seen in FIG. 2) to generate the magnetic field M within the susceptor 20. The magnetic field M is oriented substantially parallel with respect to the first axis A-A of the array of wires 40. It is to be appreciated that while FIG. 5 illustrates the coil windings 90 as being substantially perpendicular with respect to the array of wires 40 of the susceptor 20, the coil windings 90 may be oriented in other directions as well, however, the arrangement as shown in FIG. 5 results in the magnetic field M being oriented in the same direction as the array of wires 40 of the susceptor 20. Orienting the magnetic field M parallel to the wires 40A of the susceptor 20 results in maximum heating.

The core 120 strengthens or increases the magnetic field M for a given current, where increasing the magnetic field M results in increased heating of the susceptor 20 (FIG. 2). As a result, the size of the AC source 92 may be reduced, since less AC power is required to produce the same level of heating when compared to an induction-heating system without the core 120. In an embodiment, the additional weight of the core 120 is offset by the reduced size of the AC source 92, thereby creating an overall reduction in weight of the induction-heating system 10. Furthermore, although the figures illustrate the core 120 as a solid block, it is to be appreciated that the core 120 is not limited to this configuration. For example, in another embodiment, the core 120 may be constructed of densely packed conducting iron wires. In an example, the core 120 is constructed of ferrite powder in a thermoplastic or epoxy, however, other approaches may be used as well to fabricate the core 120.

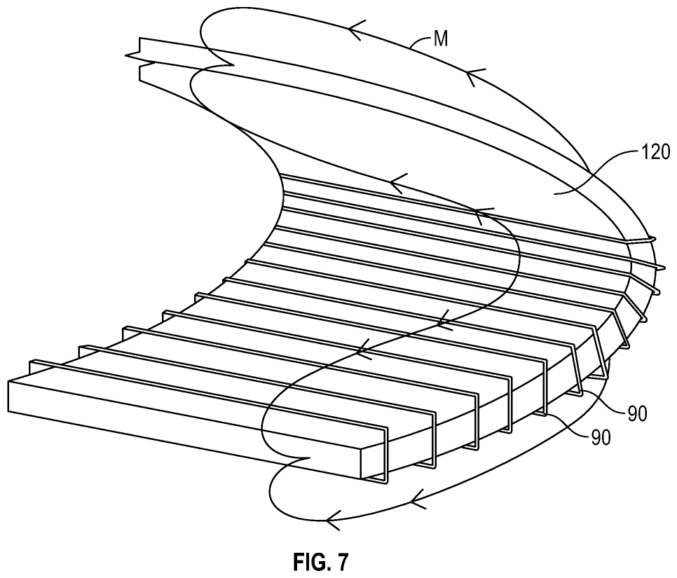

FIG. 6 is an alternative embodiment of the susceptor 20 where the first axis A-A extends along a perimeter 102 of a cross-sectioned area 104 of the support substrate 42. Accordingly, the array of wires 40 are arranged to extend along the perimeter 102 of the cross-sectioned area 104 of the support substrate 42 as well. In the embodiment as shown in FIG. 6, the wires 40A are spaced at equal distances from one another. FIG. 7 is an illustration of the electrically conductive coil 22 wound around the core 120 that corresponds to the susceptor 20 illustrated in FIG. 6. Referring to both FIGS. 6 and 7, the plurality of coil windings 90 are oriented substantially perpendicular with respect to the first axis A-A of the array of wires 40 shown in FIG. 6. Therefore, the plurality of coil windings 90 are substantially parallel with respect to the leading edge 50 of the flight surface 30 (FIG. 1). Similar to the embodiment as shown in FIGS. 2 and 5, the magnetic field M is also substantially parallel with respect to the array of wires 40A.

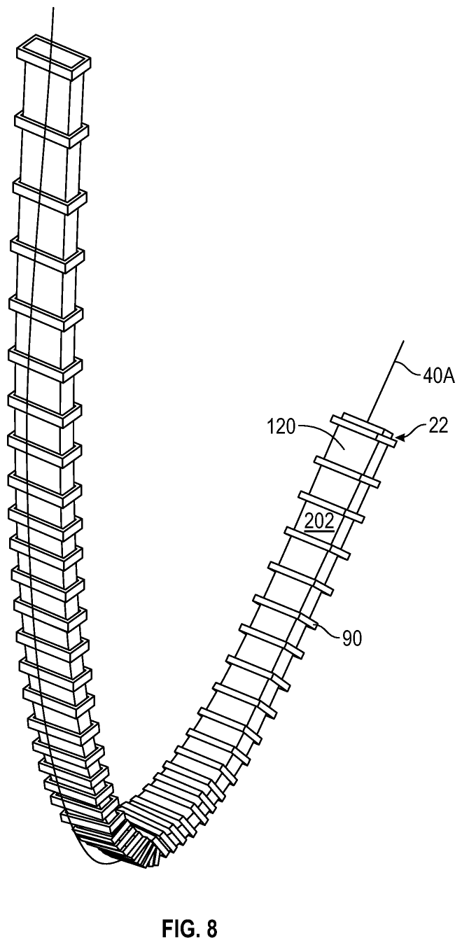

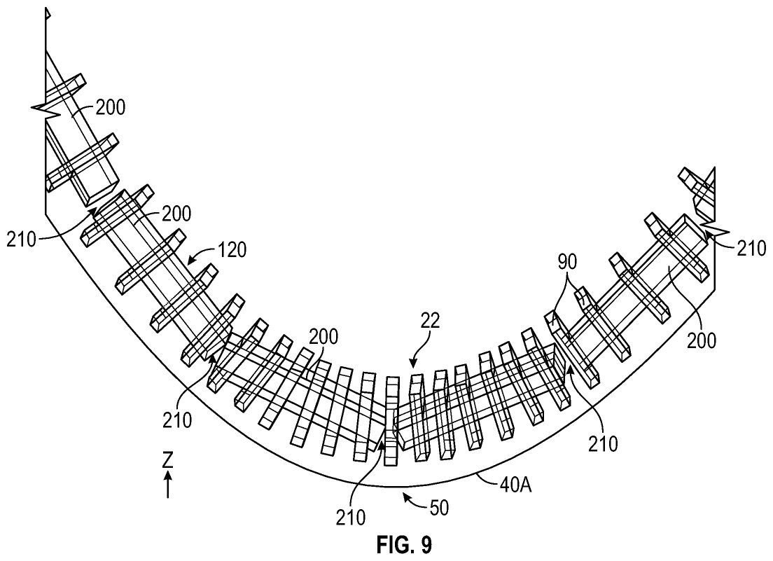

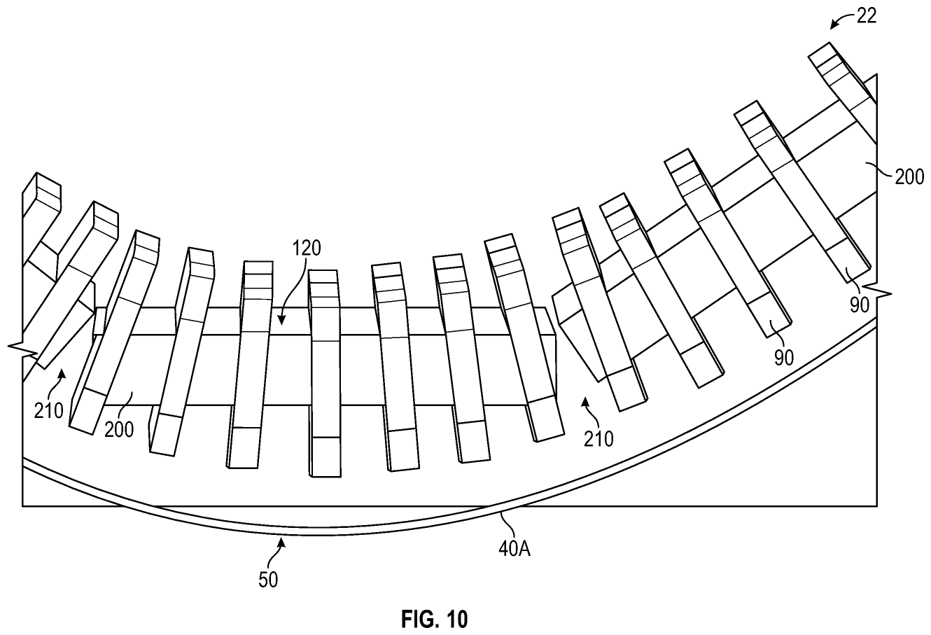

FIG. 8-10 illustrate various embodiments of the core 120 shown in FIGS. 5 and 7. In the embodiment as shown in FIG. 8, the electrically conductive coil 22 is wound around a single continuous core 120. That is, the core 120 is constructed of a single, continuous core of ferrite 202. A single one of the individual wires 40A of the array of wires 40 (shown in FIG. 2) are also illustrated in FIG. 8 for reference. Although FIG. 8 illustrates a continuous core 120, it is to be appreciated that the core 120 may be composed of individual segments as well. For example, in the embodiment as shown in FIGS. 9 and 10, the core 120 is comprised of a plurality of individual cores 200 instead. The individual cores 200 are arranged in discrete positions within the electrically conductive coil 22. In the example as shown in FIGS. 9 and 10, the plurality of individual cores 200 are arranged in discrete positions to create air gaps 210 between the plurality of individual cores 200. In the embodiment as shown in FIG. 9, one of the air gaps 210 are disposed at the leading edge 50 of the flight surface 30 (FIG. 1). However, in the embodiment as shown in FIG. 10, one of the individual cores 200 are disposed at the leading edge 50 of the flight surface 30.

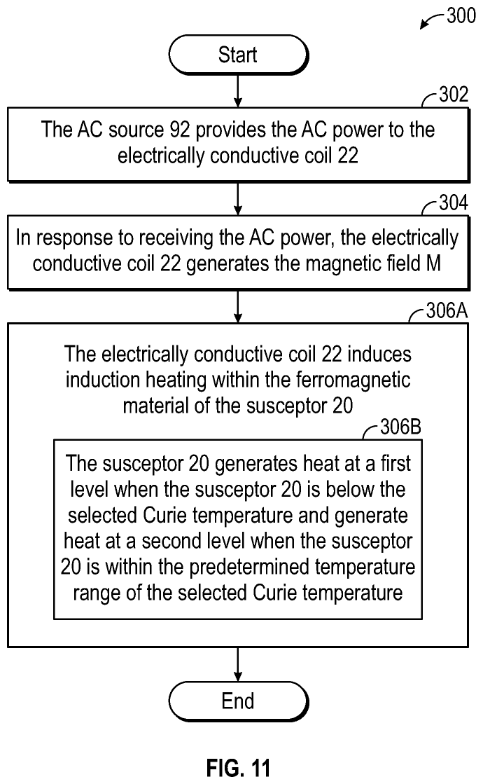

FIG. 11 is an exemplary process flow diagram illustrating a method 300 for inductive heating for deicing and anti-icing the flight surfaces 30 of the aircraft 32 (seen in FIG. 1). Referring now to FIGS. 1, 5, and 11, the method 300 begins at block 302. In block 302, the AC source 92 (FIG. 5) provides the AC power to the electrically conductive coil 22 including the plurality of coil windings 90. The method 300 then proceeds to block 304.

In block 304, in response to receiving the AC power, the electrically conductive coil 22 generates the magnetic field M. Referring to FIGS. 2 and 5, the magnetic field M is oriented substantially parallel with respect to the first axis A-A of the array of wires 40. The method 300 may then proceed to block 306A.

In block 306A the electrically conductive coil 22 induces induction heating within the ferromagnetic material of the susceptor 20 when the susceptor 20 is below the selected Curie temperature to heat the deicing and anti-icing flight surfaces 30 (FIG. 1). Specifically, as seen in block 306B, the susceptor 20 generates heat at the first level when the susceptor 20 is below the selected Curie temperature and generates heat at the second level when the susceptor 20 is within the predetermined range of the selected Curie temperature. The method 300 may then terminate.

Referring generally to the figures, the disclosed induction-heating system provides various technical effects and benefits. Specifically, the susceptor and conductive coil both include geometries that substantially eliminate cold spots within the heating system and provide uniform heating to the flight control surfaces of the aircraft. The disclosed susceptor is constructed of a ferromagnetic material that generates intense heat at a relatively cold temperatures, such as temperatures at or below the freezing point of water. However, once the susceptor is heated to a leveling temperature range of the ferromagnetic material, then the amount of heat generated by the susceptor is substantially reduced. This is because a relative permeability of the ferromagnetic material of the susceptor decreases monotonically at the leveling temperature range. The reduction in relative permeability limits generation of heat at portions of the susceptor that are within the leveling temperature range. As a result, the susceptor provides uniform heating to a flight surface. Furthermore, the disclosed induction-heating system is efficient and relatively simple to install, since few if any fasteners are required.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. An induction-heating system, comprising:
a susceptor located proximate to a flight surface of an aircraft, wherein the susceptor comprises an array of wires arranged along a first axis, the array of wires constructed of a ferromagnetic material having a selected Curie temperature; and
an electrically conductive coil including a plurality of coil windings oriented substantially perpendicular with respect to the first axis of the array of wires, wherein the electrically conductive coil is configured to generate a magnetic field oriented substantially parallel with respect to the first axis of the array of wires, the electrically conductive coil positioned to induce induction heating within the ferromagnetic material of the susceptor when the susceptor is below the selected Curie temperature.

2. The induction-heating system of claim 1, wherein the susceptor generates heat at a first level when the susceptor is below the selected Curie temperature and generates heat at a second level when the susceptor is within a predetermined range of the selected Curie temperature.

3. The induction-heating system of claim 2, wherein a ratio between the first level and the second level is at least 10:1.

4. The induction-heating system of claim 2, wherein the predetermined range is equal to a leveling temperature range of the ferromagnetic material of the array of wires.

5. The induction-heating system of claim 1, wherein the array of wires of the susceptor are oriented to follow an outer contour of the flight surface of the aircraft.

6. The induction-heating system of claim 1, further comprising an alternating current (AC) source, wherein the AC source is electrically connected to and provides AC power to the electrically conductive coil.

7. The induction-heating system of claim 1, wherein the array of wires of the susceptor are each spaced at least a minimum distance apart from one another.

8. The induction-heating system of claim 7, wherein the minimum distance is equal to at least one-half a diameter of the array of wires of the susceptor.

9. The induction-heating system of claim 1, wherein the flight surface of the aircraft defines a leading edge, and wherein the array of wires of the susceptor are spaced at a minimum distance at the leading edge of the flight surface.

10. The induction-heating system of claim 9, wherein a wire distance measured between the array of wires increases as a distance between an individual wire and the flight surface increases.

11. The induction-heating system of claim 1, wherein the selected Curie temperature is less than a structural temperature of a material of the flight surface.

12. The induction-heating system of claim 1, wherein the susceptor is constructed of at least one of the following: a nickel iron chromium alloy, a nickel iron copper alloy, a nickel iron vanadium alloy, a nickel cobalt copper alloy, a nickel copper alloy, and a nickel aluminum alloy.

13. The induction-heating system of claim 1, further comprising a core constructed of ferrite, wherein the electrically conductive coil is wound around the core.

14. The induction-heating system of claim 13, wherein the core is constructed of a single, continuous core of ferrite.

15. The induction-heating system of claim 13, wherein the core is comprised of a plurality of individual cores.

16. An aircraft, comprising:
a susceptor located proximate to a flight surface of an aircraft, wherein the susceptor comprises an array of wires arranged along a first axis, the array of wires constructed of a ferromagnetic material having a selected Curie temperature; and
an electrically conductive coil including a plurality of coil windings that are oriented substantially perpendicular with respect to the first axis of the array of wires, wherein the electrically conductive coil is configured to generate a magnetic field oriented substantially parallel with respect to the first axis of the array of wires, the electrically conductive coil positioned to induce induction heating within the ferromagnetic material of the susceptor when the susceptor is below the selected Curie temperature, wherein the susceptor generates heat at a first level when the susceptor is below the selected Curie temperature and generates heat at a second level when the susceptor is within a predetermined range of the selected Curie temperature.

17. The aircraft of claim 16, wherein the flight surface is one of the following: a leading edge of a wing, a trailing edge of a wing, an engine cowling, and an empennage.

18. The aircraft of claim 17, wherein a ratio between the first level and the second level is at least 10:1.

19. A method for inductively heating deicing and anti-icing flight surfaces of an aircraft, the method comprising:
providing alternating current (AC) power to an electrically conductive coil including a plurality of coil windings that are oriented substantially perpendicular with respect to a first axis of an array of wires that are part of a susceptor, wherein the susceptor is located proximate to the deicing and anti-icing flight surfaces and the array of wires constructed of a ferromagnetic material having a selected Curie temperature;
in response to receiving the AC power, generating, by the electrically conductive coil, a magnetic field oriented substantially parallel with respect to the first axis of the array of wires; and
inducing, by the electrically conductive coil, induction heating within the ferromagnetic material of the susceptor when the susceptor is below the selected Curie temperature to heat the deicing and anti-icing flight surfaces.

20. The method of claim 19, further comprising:
generating, by the susceptor, heat at a first level when the susceptor is below the selected Curie temperature; and
generating heat at a second level when the susceptor is within a predetermined range of the selected Curie temperature, wherein the first level is greater than the second level of heating.
